(19) United States
(12) Patent Application Publication
(10) Pub. No.: US 2024/0086834 A1
(43) Pub. Date: Mar. 14, 2024

(54) SYSTEMS AND METHODS FOR MANAGEMENT OF MULTIPLE VENDORS AND SELF-SERVICE ORDERING POINTS

(71) Applicant: Grubbrr SPV LLC, Boca Raton, FL (US)

(72) Inventor: Bhavin Asher, Boca Raton, FL (US)

(21) Appl. No.: 17/943,011

(22) Filed: Sep. 12, 2022

(51) Int. Cl. G06Q 10/08

(52) U.S. Cl. CPC G06Q 10/087

(57) ABSTRACT

System and method for managing a customer ordering point that is connected to a plurality of vendor systems is provided. An electronic communication is received including a first order having a first plurality of order components. A first order component requires fulfillment from a first vendor system and a second order component requires fulfillment from a second vendor system. It is determined from information embedded in the electronic communication that the first order component should be fulfilled from the first vendor system and the second order component should be fulfilled by the second vendor system. Communication is initiated with the first vendor system and the second vendor system. The first vendor system is caused to fulfill the first order component and the second vendor system to fulfill the second order component.

### BACKGROUND OF THE INVENTION

Customer self-service and checkout is growing in prominence in retail and restaurant spaces. A typical arrangement provides customers with ordering points at which they can use technological tools to view inventory, make selections, and pay for an order without significant interaction with vendor employees. The vendors receive these orders, manage their fulfillment, and then deliver the items to customers at designated delivery points.

One example is a food court. Some food courts have multiple restaurants, which each provide a customer self-service option to their customers. For example, one vendor will have a first ordering point designated solely for its customers and another vendor will have a second ordering point designated solely for its customers. Such an arrangement is relatively straightforward for simple transactions in which a single customer orders from a single vendor. The customer simply interacts with the ordering point of the vendor in question and completes a transaction.

A problem exists, however, when a customer wants to order from multiple vendors. In such a scenario, the customer must navigate to and interact with multiple ordering points, one for each vendor of interest. The problem becomes even more complex when a purchasing entity is comprised of multiple people, each who want to order from a different vendor or vendors. And even with respect to the same vendor, individual or subsets of purchasers may want to place or modify orders for different items or may desire fulfillment at different times. Such scenarios render self-service and multiple vendor facilities as a less attractive option because of the time involved in the ordering process. Accordingly, there is a need for systems and methods to provide customers with faster and more efficient checkout processes that also allows multiple vendors to efficiently manage orders, resource allocation while reconciling backend financial systems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

In one embodiment, a method for managing a customer ordering point that is connected to a plurality of vendor systems is provided. An electronic communication is received including a first order having a first plurality of order components. A first order component requires fulfillment from a first vendor system and a second order component requires fulfillment from a second vendor system. It is determined from information embedded in the electronic communication that the first order component should be fulfilled from the first vendor system and the second order component should be fulfilled by the second vendor system. Communication is initiated with the first vendor system and the second vendor system. The first vendor system is caused to fulfill the first order component and the second vendor system to fulfill the second order component.

In one embodiment, a second order is received that includes a second plurality of order components. In one embodiment, at least one predetermined criteria is utilized to determine priority of the first order relative to the second order. In one embodiment, the first order has priority over the second order because it was received first. In one embodiment, a first predetermined criteria and a second predetermined criteria are employed to determine priority of the first order relative to the second order. In one embodiment, the second predetermined criteria has a greater weight than the first predetermined criteria. In one embodiment, the first predetermined criteria is a relative time of receipt of the first order and the second order, and the second predetermined criteria is a relative size of the first order and the second order. In one embodiment, determining comprises dynamically analyzing the first order component and the second order component to determine that the first order component should be fulfilled by the first vendor and the second order component should be fulfilled by the second vendor. In one embodiment, determining comprises extracting information from the electronic communication to determine that the first order component should be fulfilled by the first vendor and the second order component should be fulfilled by the second vendor. In one embodiment, characteristics of a user of the ordering point are determined. Information provided by the first vendor system and the second vendor system is utilized to create a custom interface for the user. The ordering point share the customer experience with the user.

In one embodiment, a system is provided for managing a customer ordering point that is connected to a plurality of vendor systems. A communication interface is operable to receive an electronic communication including a first order having a first plurality of order components. A first order component requires fulfillment from a first vendor system and a second order component requires fulfillment from a second vendor system. An order management module that executes instructions to determine from information embedded in the electronic communication that the first order component should be fulfilled from the first vendor system and the second order component should be fulfilled by the second vendor system; initiate communication with the first vendor system and the second vendor system; and cause the first vendor system to fulfill the first order component and the second vendor system to fulfill the second order component.

In one embodiment, the communication interface is operable to receive a second order that includes a second plurality of order components. In one embodiment, the order management module further executes instructions to utilize at least one predetermined criteria to determine priority of the first order relative to the second order. In one embodiment, the order management module selects the first order to have priority over the second order because it was received first. In one embodiment, the order management module employs a first predetermined criteria and a second predetermined criteria to determine priority of the first order relative to the second order. In one embodiment, the order management module provides the second predetermined criteria to have a greater weight than the first predetermined criteria. In one embodiment, the first predetermined criteria is a relative time of receipt of the first order and the second order, and the second predetermined criteria is relative size of the first order and the second order. In one embodiment, the order management module executes instructions to dynamically analyze the first order component and the second order component to determine that the first order component should be fulfilled by the first vendor and the second order component should be fulfilled by the second vendor. In one embodiment, the order management module executes instructions to extract information from the electronic communication to determine that the first order component should be fulfilled by the first vendor and the second order component should be fulfilled by the second vendor. In one embodiment, a user interface management module executes instructions to identify characteristics of a user of the ordering point; utilize information provided by the first vendor system and the second vendor system to create a custom interface for the user; and cause the ordering point to share the customer experience with the user.

### BRIEF DESCRIPTION OF THE FIGURES

A more detailed understanding may be had from the following description, given by way of example in conjunction with the accompanying figures wherein:

FIG. 1A is a functional block diagram of a multiple vendor environment including an ordering point and a multiple vendor management module (MVMM);

FIG. 1B is a block diagram depicting exemplary technological components of the MVMM shown in FIG. 1A that provide example operations;

FIG. 1C is a block diagram depicting exemplary management of an order shown in FIG. 1B;

FIG. 1D is block diagram depicting an exemplary prioritization system that may be utilized in the system of FIG. 1A.

FIG. 2 illustrates an exemplary process utilized performed by the technological system of FIG. 1;

FIG. 3 is an exemplary block diagram representing a computer system in which aspects of the processes and systems disclosed herein or portions thereof may be incorporated.

### DETAILED DESCRIPTION

The present disclosure is directed to systems and methods for management of multiple ordering points that are functional to interact with multiple vendors systems. It is to be appreciated that the claimed subject matter is described below more fully with reference to the accompanying figures, in which illustrated embodiments of are shown. The claimed subject matter is not limited in any way to the illustrated embodiments as the illustrated embodiments described below are merely exemplary of the claimed subject matter, which can be embodied in various forms. Therefore, it is to be understood that any structural and functional details disclosed herein are not to be interpreted as limiting, but merely as a basis for the claims and as representative for teaching one skilled in the art to variously employ the claimed subject matter. Furthermore, the terms and phrases used herein are not intended to be limiting but rather to provide an understandable description of the claimed inventions.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below may include a software algorithm, program or code residing on computer useable medium having control logic for enabling execution on a machine having a computer processor, and the computer or machine on which such software runs. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine, or accessed over the Internet (e.g., web based or Software as a Service (SoS). The embodiments described herein include such software to implement the functionality, equations, relationships and algorithms described above. One skilled in the art will appreciate further features and advantages of the invention based on the above-described embodiments. Accordingly, the inventions are not to be limited by what has been particularly shown and described, except as indicated by the appended claims.

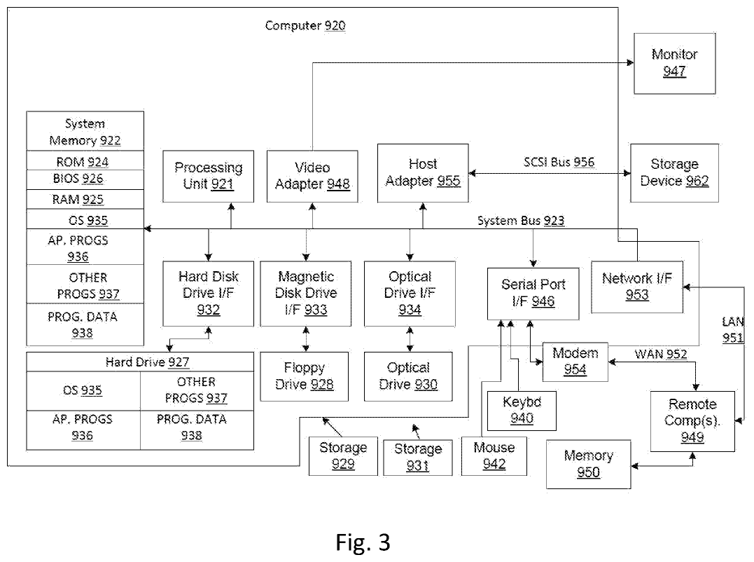

In the description and figures provided herein, reference is made to modules, components, engines, and the like. It should be understood that engines, modules, and components may be hardware and/or software components that are executable by a processor to perform the functionality described with respect to the particular engine, module, and/or component. An exemplary, computing device is depicted in connection with FIG. 3 for illustrative purposes although such engines, modules, and components could operate of a multitude of different devices without departing from the scope of the disclosure herein.

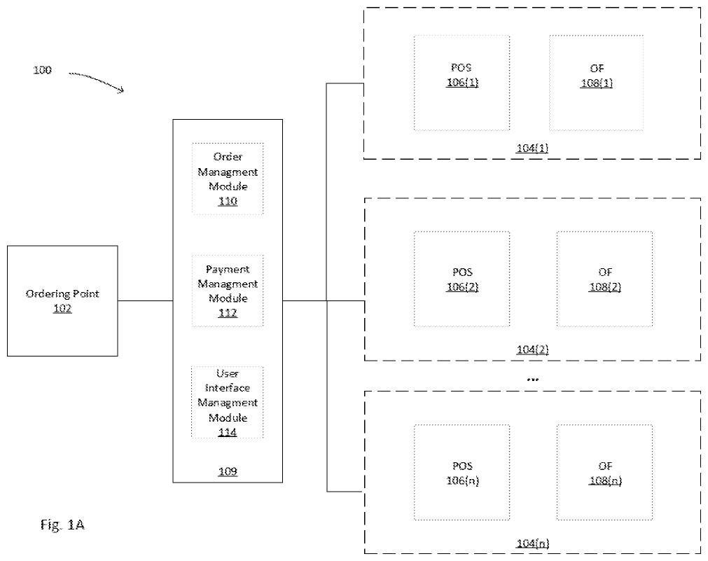

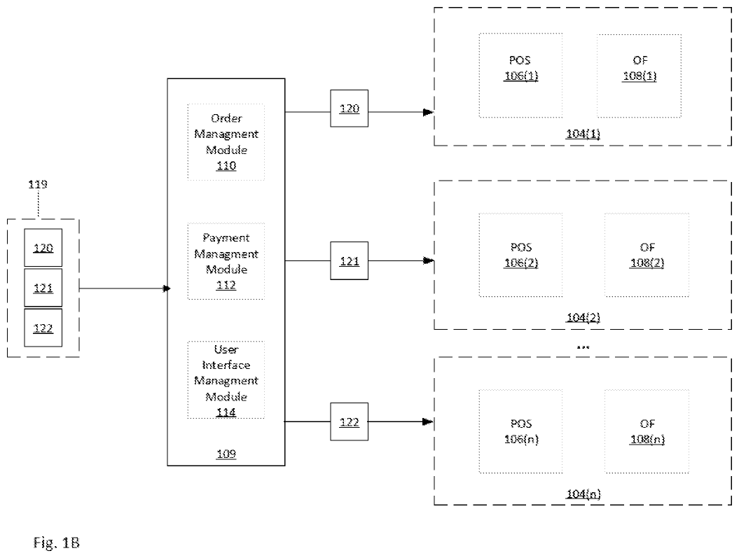

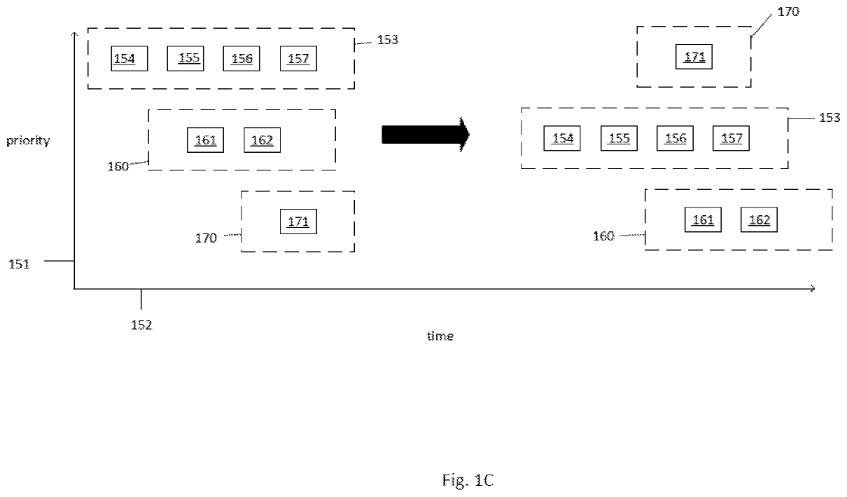

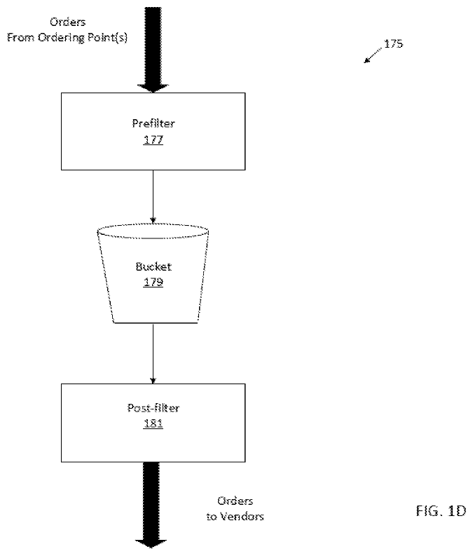

Referring to FIG. 1A, a system 100 is depicted which includes at least one instance of an ordering point 102 and a plurality of vendor systems 104(1) . . . 104(n).

In one example, ordering point 102 is a self-service kiosk. In another example, ordering point 102 is an ordering app operating on a computer or mobile device. For instance, there may be a gateway designed to allow a user to order directly from a user device. Such a gateway may be designed to allow the user to order when he/she is in the same location as the vendor systems 104(1) . . . 104(n) or at a different location. As another alternative, the system may be designed to permit an employee of a vendor to operate an ordering point 102 and take orders directly from a customer. One ordering point 102 is shown for illustrative purposes, but there may be multiple ordering points 102. Furthermore, multiple ordering points 102 could be various combinations of self-service kiosks, remote access, vendor operated checkout devices, and the like.

Ordering point 102 is where a user places an order into system 100 for eventual delivery to a customer. Ordering point 102 will generally have one or more input/output devices that allow a customer to interact with the system and place orders. Ordering point 102 will generally have one or more communication interfaces that allow ordering point 102 to connect to and integrate with vendors 104(1) . . . 104(n). Ordering point 102 may also have one or more communication interfaces to allow it to connect to one or more networks, such as the internet. Ordering point 102 may be designed to communicate with vendor systems 104(1) . . . 104(n) over such network interfaces. Customers in some implementations may connect to system 100 over networks and place orders. An exemplary embodiment of a device that could function as ordering point is shown in FIG. 3.

Referring further to FIGS. 1A, in one embodiment, vendor systems 104(1) . . . 104(n) include a point of sale system 106(1) . . . 106(n) and an order fulfillment system 108(1) . . . 108(n). Point of sale systems 108(1) . . . 108(n) provides the customer facing technology that allow customers to purchase products from vendors 104(1) . . . 104(n). For instance, in addition to utilizing ordering point 102, a particular vendor may have a traditional cashier/cash register system, which allows customers to interact with vendor employees and to place orders. It is understood that ordering point 102 may be integrated with such systems. It is also understood that vendor systems 104(1) . . . 104(n) may have differently manufacturers of POSs 106(1) . . . 106(n). For instance, vendor system 104(1) may have a POS 106(1) provided by Oracle® and vendor system 104(2) may have a POS 106(2) provided by NCR®. The functionality provided herein operates across multiple different POS devices and systems.

Vendor systems 104(1) . . . 104(n) also include an order fulfillment system 108(1) . . . 108(n). Order fulfillment system 108(1) . . . 108(n) is an illustrative term to describe the back end systems by which a vendor manages and fulfills orders from customers. Order fulfillment systems 108(1) . . . 108(n) have functionality based on the particular product and/or service the vendor provides. For example, in the retail environment, order fulfillment systems 108(1) . . . 108(n) may include systems for the vendor to manage its supply chain, track inventory, locate inventory, retrieve inventory, and deliver inventor to a customer. In the restaurant environment, an order fulfillment system may include kitchen management systems designed to allow employees to track and fulfill orders as they are submitted. Such systems may include a kitchen display system (KDS) that includes one or more input/output devices (e.g., touchscreens) that allow cooks to select orders for fulfilment and to indicate when orders have been fulfilled. FIG. 3 depicts an exemplary device that could be used to implement the functions provided by vendor systems 104(1) . . . 104(n). The description of vendor systems 104(1) . . . 104(n) is not exhaustive and is provided to help illustrate the principles set forth herein. It should be understood that vendor systems 104(1) may have additional functionality to that which is described herein.

The vendors operating vendor systems 104(1) . . . 104(n) may have one or more methods and/or mechanisms by which they deliver items to customers. These are not shown in detail, but examples include, but are not limited to: A vendor designating a pick-up area for orders or provide delivery to a customer location; delivery could also be accomplished through automated means, such as robots, UAVs, and automated locker apparatuses. Vendor systems 104(1) . . . 104(n) may have communications interfaces set up to directly communicate with customers, such as to provide them with payment receipts or to notify them that their orders are ready for pick-up. For instance, customers may have provided telephone numbers or email addresses to vendors, such that vendor systems 104(1) . . . 104(n) can communicate with customers.

Referring further to FIG. 1A, system 100 includes multiple vendor management module (MVMM) 109. MVMM 109 in one example includes order management module 110, payment management module 112, and user interface management module 114. MVMM 109 provides functionality that allows ordering point 102 to interact with multiple vendor systems 104(1) . . . 104(n). For example, MVMM 109 in one example has multiple hardware and/or software interfaces that allow it to interoperate with vendor systems 104(1) . . . 104(n).

An exemplary device on which MVMM 109 may be implemented is provided in FIG. 3. MVMM 109 also may be implemented as part of an ordering point 102 or as a stand along device. As another alternative, MVMM 109 may be implemented on a plurality of devices as a distributed processing environment. MVMM 109 may be implemented in the same location as vendor systems 104(1) . . . 104(n) or implemented elsewhere, such as a cloud based service. Furthermore, in some alternatives, ordering point 102, vendor systems 104(1) . . . 104(n), and MVMM 109 could be combined or divided. The block diagrams are provided to assist in describing the functionality of system 100, not to define specific points of demarcation within system 100.

Order management module 110 is utilized by MVMM 109 to manage the orders received from ordering point 102. Referring now to FIG. 1B, an exemplary representation of an order 119 received by MVMM 109 from ordering point 102 is shown for illustrative purposes. An order component in one example corresponds to one or more products or items that are included in a customer order. Order 119 is shown as having three components: An order component 120 for an item from vendor 104(1); an order component 121 for an item from vendor 104(2); and an order component 122 for an item from vendor 104(3).

Order management module 110 receives order 119 and determines that order component 120 should be fulfilled by vendor 104(1) and then routes the order to vendor 104(1) for fulfillment. Similarly order management module 110 determines that order component 121 should be fulfilled by vendor 104(2) and routes the order to vendor 104(2) for fulfillment. A similar routing occurs for component 122, which is routed to vendor 104(n). When the various order components are fulfilled by respective vendor systems 104(1) . . . 104(n), order management component 110 receives notification of such fulfillment and can then notify the customer of such fulfillment. In one example, order management module 110 may be designed to notify customers on a rolling basis, as order components are fulfilled, or may provide one notification as the entire order 119 is fulfilled. The customer could then receive the entire order 119 in accordance with a designated collection or delivery mechanism.

Order management module 110 may determine that an order component should be routed to a particular vendor 104(1) . . . 104(n) in one or more ways. For instance, order management module 110 may receive input from ordering point 102 that can use to make such a determination. Ordering point 102 may have a menu based system in which the user has a first menu for vendor 104(1), a second menu for vendor 104(2), and so forth. Order management module 110 can determine that items from the first menu are for vendor 104(1), items from the second menu are for vendor 104(2) and so on. In another example, order management module 110 may receive order 119 from ordering point 102 and analyze the order in its entirety to determine which vendor 104(1) . . . 104(n) should receive which order component(s). For example, order management module may use machine learning or artificial intelligence to analyze an order vis-à-vis the characteristics (inventory, products, vendor type) of the vendors 104(1) . . . 104(n) and make a determination as to which items belong to which vendors. Such functionality would allow system 100 to add vendors without engaging in a protracted implementation process.

Referring further to FIG. 1B, payment management module 112 in one example is designed to collect payment from the users/customers and interfaces with the corresponding POS 106(1) . . . 106(n) to deliver payment to the corresponding vendor 104(1) . . . 104(n). For example, order components 120, 121, 122 will each have a price associated with it. Payment management module 112 will collect payment for order 119 and allocate funds for order component 120 to POS 106(1), order component 121 to POS 106(2), and order component 122 to POS 106(3). Allocation of funds does not necessarily mean that funds are transferred to the respective vendors 104(1) . . . 104(n) at the time of sale, although payment could be dynamically performed in such a manner. Payment management module 112 could notify each POS 106(1) . . . 106(n) that it has collected the funds and there could be a settlement of funds at a later time, for instance as a batch process.

Referring to FIG. 1C, in one embodiment, order management module 110 (see FIG. 1A) may also analyze the various orders that it has pending, from all ordering points, and manage how and when the orders get fulfilled. FIG. 1C, depicts a priority axis 151 and a time axis 152. There are three orders shown: Order 153 comprising order components 154, 155, 156, 157; order 160 comprising order components 161, 162; and order 170 comprising order component 171. The orders are grouped on the priority axis 151 and the time axis 152 in ascending order. Therefore, order 153 was received first and is initially given highest priority. Order 160 was received second and given second priority; and order 170 was receive third and given the lowest priority.

Referring further to FIG. 1C, order management module 110 in one embodiment may elect to fulfill orders on a first-in first-out (FIFO) basis. The vendors prioritize those orders that are received first without discriminating on the size or type of order. Such a methodology may work for vendors who have similar products or similar demand patterns. However, for vendors who sell different products or who have different demand patterns, it may be useful to prioritize orders based on multiple criteria.

Accordingly, order management module 110 in one embodiment may be designed and built to employ multiple factors to determine priority. Such criteria may include the fulfillment times of the vendors, the size of the orders, the complexity of the orders, and so forth. In addition, order management module may be constructed to use one criterion to prioritize and then periodically rebalance the system using another criterion. In FIG. 1C, the system uses data messages representing the size of the order to reprioritize orders that have already been received. Order 153 was received first but comprises four components 154, 155, 156, 157. Order 160 was received second and contains two components 161, 162. Order 170 was received last, but only contains one component 171. Order management module 110 is built to rebalance the order priority by moving order 170 to the top of the queue because it would be faster to fulfill and could be fulfilled at roughly the same time as order 153. In another example, order management module 110 may determine that a particular vendor is taking a much longer time to fulfill orders than others. Accordingly, any orders having an order component to be fulfilled by such a vendor would be moved to a lower priority because the entirety of those orders would not be fulfilled regardless of the other vendor's performance. Similarly, some orders may be simpler to perform than others and therefore are moved to the top of the priority queue. For example, an order for a pizza may arrive before an order for two coffees and an ice cream. Yet, because is faster two prepare two coffees and an ice cream, the second order could be given priority over the first order despite the earlier order being for one item and the second order being for three items. In one embodiment, machine learning may be utilized to dynamically change the priority of orders and order components.

Referring now to FIG. 1D, in one embodiment, order management module 110 may utilize system 175 to manage order fulfillment. In one example, system 175 comprises a prefilter 177, a bucket 179, and a post-filter 181. Prefilter 177 receives orders from one or more ordering points 102. Orders may comprise one or more order components (see, e.g., FIG. 1B and FIG. 1C). Prefilter 177 analyzes orders based on one or more predetermined criteria. For each order, prefilter 177 sends the order, in whole or in part, to bucket 179 for further processing or does not send all or some of the order to bucket 179 for further processing. If prefilter 177 does not send all or a part of an order to bucket 179 for further processing, then user interface module 114 (FIG. 1A) will be notified and it can communicate the same to a customer.

For example, in one embodiment, prefilter 117 may analyze an order and determine to insure that orders can be fulfilled by vendors 104(1) . . . 104(n) (FIG. 1A). For instance, one or more vendors 104(1) . . . 104(n) may be closed, out of a certain item and not accepting certain requests, or have more orders than what one or more vendors 104(1) . . . 104(n) has the capacity to fulfill. Prefilter 117 determines whether one or more order components can not be fulfilled by a vendor 104(1) . . . 104(n). If an order cannot be fulfilled by a vendor, then prefilter notifies user interface module 114, which can communicate with a customer and determine how the customer wants to proceed, such as by cancelling the entire order, substituting for the order component, or removing the order component from the order. A determination as to whether or not order components can be fulfilled may be based on specifications received from vendor(s) 104(1) . . . 104(n)

When the prefilter 117 is done operating on an order, it either rejects the order, accepts the order, or modifies the order such that it can be accepted. If it accepts or modifies the order, it will send the order to bucket 179. Bucket 179 in one example then holds the order and assigns a priority to the order. In one example, bucket 179 holds and prioritizes a plurality of orders. Each vendor 104(1) . . . 104(n) may set a limit of orders (for example, 30). Vendors 104(1) . . . 104(n) may also limit the size of bucket 179. If the bucket is maxed, then the highest prioritized order is transferred from the bucket 179 to the respective vendor 104(1) . . . 104(n). Prioritized orders are then sent to post-filter 181, which then sends the orders to vendor(s) 104(1) . . . 104(n) based on one or more criteria.

In one embodiment, post-filter 181 sends orders to vendors 104(1) . . . 104(n) in order of priority. That is, the highest priority orders will be sent to the vendor(s) 104(1) . . . 104(n) first. In one embodiment, a plurality of criteria may be utilized to determine which orders should be sent to vendor(s) 104(1) . . . 104(n) first. It should be noted that system 175 in one example may be configured such that bucket 179 and post-filter 181 may be configured to operate at the order level or the order component level. For instance, individual order components may be prioritized and sent to vendor(s) 104(1) . . . 104(n) individually, or order components may only be sent to vendors 104(1) . . . 104(n) at the same time as the other orders components are sent to vendors 104(1) . . . 104(n). In other words, an order component is only sent to a vendor 104(1) . . . 104(n) if the entire order can be sent. If a vendor 104(1) . . . 104(n) will not accept an order component yet (e.g. due to load), then the entire order is held in bucket 179 and reprioritized.

For example, if an order has two order components, one for vendor 104(1) and one for vendor 104(2). The order for vendor 104(1) may initially have a higher priority than the order for vendor 104(2). However, vendor 104(1) may have reached capacity and indicated to system that it needs to pause before fulfilling its order. In this scenario, post-filter 181 may elect to send the order for vendor 104(2) first and keep the order for 104(1) in bucket 179 where it can be reprioritized.

In one example, priority may be determined by weighting a plurality of parameters. Examples of parameters include, order type, order channel, number of items in order, user waiting time, preparation time, and customer type. An exemplary, formula for determining priority may be:

Priority score=1×OT+0.75×OC+1×WT+0.5×IN

Where OT is Order Type, OC is order channel, WT is wait time, and IN is item numbers. Order Type in one example is the type of order (e.g. dine-in, takeout, delivery, etc.). Order Channel in one example is from what source the order is originating from (e.g. online, phone, kiosk, etc.). Wait time is the amount of time that a customer has been waiting for an order. Item numbers are the number of items in a particular order or order component.

In one example, vendors 104(1) . . . 104(n) may assign order priority to different order types OT. For example, High Priority may be given a value of X; Mi Priority may be X−1; and Low Priority may be X−2. In one example, vendors 104(1) . . . 104(n) may assign priorities to different order channels OC. For example, High Priority may be given a value of Y; Mi Priority may be Y−1; and Low Priority may be Y−2.

In one example, vendors 104(1) . . . 104(n) may assign different priorities based on item numbers in an order or order component. For instance, 1-6 items may receive a value of Z, 7-12 items may receive a value of Z−1, and 13+ items may receive a value of Z−2.

As for wait time WT, priority may be based on an ascending scale from a baseline value. So, if an average wait time is about 5 minutes, an exemplary WT prioritization could be calculated as follows:

| 0-5 | 5-10 | 10-15 | 15-20 | 20-25 | 25-30 | 30 |
|---|---|---|---|---|---|---|
| Min | Min | Min | Min | Min | Min | mins+ |
| W | W + 2 | W + 4 | W + 6 | W + 8 | W + 10 | Add 2 for |
| | | | | | | every 5 mins |

With the priority score for orders in bucket 181 being recalculated as time progresses. In one embodiment, vendors 104(1) . . . 104(n) may set a ceiling waiting time WT for each order type. If the order waiting time for that order type is greater than the user set ceiling time, we double the waiting score for that order. In the table below results, can be seen for exemplary values inputted into the preceding formula.

From the table you can see that if the lowest priority order waits for 20 mins, it will have a higher score than the highest priority order:

Referring now to FIG. 1A, user interface management module 114 in one example tool that helps manage the user experience of the customers/users of ordering point 102. In one embodiment, user interface management module 114 may be constructed to receive user preferences from user and provide a user experience tailored to the user. For instance, if a user prefers vendor 104(1) and vendor 104(n), but does not prefer vendor 104(2), then user interface management module 114 may only provide ordering options for vendor 104(1) and 104(n). User preferences may be stored in a database for keeping track of user account maintained for users. In another example, user interface management module 114 may create a custom-ordering menu for a user. For instance, based on user preferences or past order history, the system can be configured to work with user interface management module 114 to prepare a list of items or orders that is an amalgamation of the offerings of all vendor 104(1) and vendor 104(n) and present them in an manner that is most useful to the user. In another example, user interface management module 114 may identify a plurality of characteristics of the user that may be useful in presenting options to the user. For instance, ordering point may be a kiosk 102 with a touch screen and a camera. The camera may capture an image of the “customer” that user interface module 114 uses to identify a parent with children of a certain age. The user interface management module 114 may then output on the touchscreen menu items that are appropriate or likely to interest those in the “customer” group. Because MVMM 109 is a multi-vendor system, the user experiences that it provides can be closely tailored to user preferences, prior user experiences, and user characteristics.

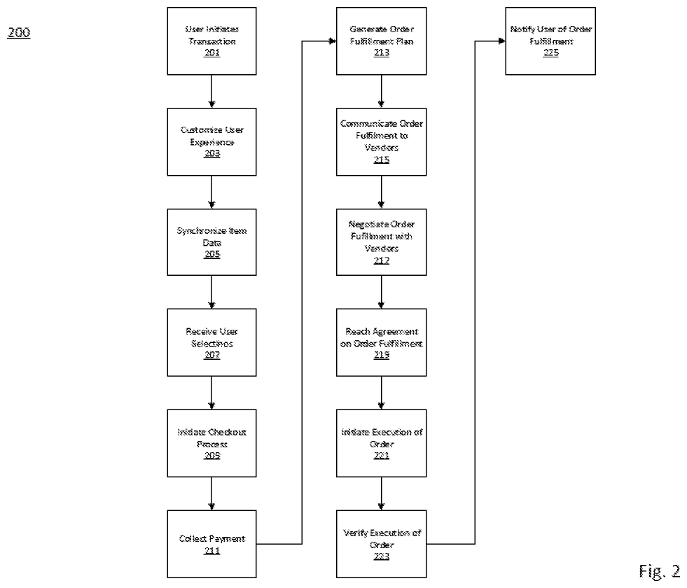

Referring to FIG. 2, an exemplary process 200 utilizing MVMM 109 is now shown for illustrative purposes. It should be noted that the steps of process 200 are provided in a particular order for illustrative purposes and not to limit the scope of the disclosure to a particular order. The steps may be rearranged, combined, divided, or removed without departing from the scope of the subject matter herein.

In step 201, a user initiates a transaction. Initiation of a transaction in one example may encompass activating an input/output device of ordering point 102. For example, a user may activate a touch screen device of a kiosk. In another example, a kiosk may detect the proximity of a user through one or more sensors, such as cameras, beacon devices, Bluetooth transceivers, etc. In another example, a user may use a third-party device, such as a smartphone or computer that connects to ordering point 102 and causes initiation of a transaction.

In step 203, MVMM 109 customizes a user experience for the user. The user experience may include textual, graphic, audio, and video communication. The user experience may include the ability for the user to provide input to MVMM 109 through ordering point 102 and to receive output from MVMM 109 through ordering point. The user experience may the items that the user may order. The items may be created based on the user's characteristics, the user's prior order history, or the user's preferences as expressed at the time of the order or at another time.

In step 205, MVMM 109 preferably synchronizes item data to insure that it is presenting the most up to date items that are available for a user. For instance, restaurants and merchants often run out of certain items due to demand or time of the day. MVMM 109 synchronizes with vendor systems 104(1) . . . 104(n) to preferably insure that only items that are available for the user are presented to the user.

In step, 207 MVMM 109 preferably receives the user's selections. As was discussed earlier, the user may provide selections in a plurality of ways. For instance, users may enter selections using a keyboard or a touch screen. However, they may also input their selections verbally or through gestures. They may also have pre-selected items for order on a smartphone, which are embedded in a code that is then communicated to MVMM 109 through a sensor such as a camera on ordering point 102.

In step 209, MVMM 109 preferably initiates the checkout process, and MVMM 109 collects payment in step 211. Payments may be collected through devices on ordering point 102, such as credit card readers, touchless payment technology, cash reader slots, bill readers, etc. Ordering point 102 in one example may use payment systems similar to POSs 106(1) . . . 106(n) in vendor systems 104(1) . . . 104(n). Payment could also be collected through services, such as Paypal®, Venmo®, ApplePay®, Zelle®, and the like.

In step 213, MVMM 213 preferably creates an order fulfillment plan. An order fulfillment plan was discussed previously in connection with FIG. 1C in which MVMM 213 determines how to prioritize orders. In step 215, the order fulfillment plan is communicated to vendor systems 104(1) . . . 104(n), and in step 217 the order fulfillment plan is negotiated with the vendor systems 104(1) . . . 104(n). The negotiation of the order preferably fulfillment plan allows the vendor systems 104(1) . . . 104(n) an opportunity to override MVMM's 213 priority determination. For instance, MVMM 213 may be using multiple variables to determine the priority for orders, but a vendor system 104(1) . . . 104(n) may prefer to be set entirely to FIFO. In such a circumstance, the vendor system 104(1) . . . 104(n) may notify MVMM 213 that all of its orders should be set for FIFO, in which case MVMM 213 would adjust the order fulfillment plan.

In step 219, order fulfillment plan is agreed upon, and in step 221, vendor systems 104(1) . . . 104(n) receive their corresponding order components and initiate execution of the order. In step 223, the MVMM 213 verifies that the order components have been executed and in step 225 notifies the user/customers of fulfillment of the order. Such notification may occur at the time each order component is fulfilled or at the completion of the entirely of the order. The notification may occur by MVMM 213 sending a notification directly to the customer, by each vendor notifying the customer, or by a combination thereof.

FIG. 3 is a block diagram representing a system in which the hardware and/or software aspects of the methods and systems disclosed herein and/or portions thereof may be incorporated. As shown, the exemplary system includes a computer 920 or the like, including a processing unit 921, a system memory 922, and a system bus 923 that couples various system components including the system memory to the processing unit 921. The system bus 923 may be any of several types of bus structures including a memory bus or memory controller, a peripheral bus, and a local bus using any of a variety of bus architectures. The system memory includes read-only memory (ROM) 924 and random access memory (RAM) 925. A basic input/output system 926 (BIOS), containing the basic routines that help to transfer information between elements within the computer 920, such as during start-up, is stored in ROM 924.

The computer 920 may further include a hard disk drive 927 for reading from and writing to a hard disk (not shown), a magnetic disk drive 928 for reading from or writing to a removable magnetic disk 929, and an optical disk drive 930 for reading from or writing to a removable optical disk 931 such as a CD-ROM or other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide non-volatile storage of computer readable instructions, data structures, program modules and other data for the computer 920. As described herein, computer-readable media is a tangible, physical, and concrete article of manufacture and thus not a signal per se.

Although the exemplary environment described herein employs a hard disk, a removable magnetic disk 929, and a removable optical disk 931, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), cloud implemented memory, and the like.

A number of program modules may be stored on the hard disk, magnetic disk 929, optical disk 931, ROM 924 or RAM 925, including an operating system 935, one or more application programs 936, other program modules 937 and program data 938. A user may enter commands and information into the computer 920 through input devices such as a keyboard 940 and pointing device 942. Other input devices (not shown) may include a microphone, joystick, game pad, satellite disk, scanner, or the like. These and other input devices are often connected to the processing unit 921 through a serial port interface 946 that is coupled to the system bus, but may be connected by other interfaces, such as a parallel port, game port, or universal serial bus (USB). A monitor 947 or other type of display device is also connected to the system bus 923 via an interface, such as a video adapter 948. In addition to the monitor 947, a computer may include other peripheral output devices (not shown), such as speakers and printers. The exemplary system of FIG. 4 also includes a host adapter 955, a Small Computer System Interface (SCSI) bus 956, and an external storage device 962 connected to the SCSI bus 956.

The computer 920 may operate in a networked environment using logical connections to one or more remote computers, such as a remote computer 949. The remote computer 949 may be a personal computer, a server, a router, a network PC, a peer device or other common network node, and may include many or all of the elements described above relative to the computer 920, although only a memory storage device 950 has been illustrated in FIG. 3. The logical connections depicted in FIG. 3 include a local area network (LAN) 951 and a wide area network (WAN) 952. Such networking environments are commonplace in offices, enterprise-wide computer networks, intranets, and the Internet.

When used in a LAN networking environment, the computer 920 is connected to the LAN 951 through a network interface or adapter 953. When used in a WAN networking environment, the computer 920 may include a modem 954 or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing a communications link between the computers may be used, such as Bluetooth and Wi-Fi.

Computer 920 may include a variety of computer readable storage media. Computer readable storage media can be any available media that can be accessed by computer 920 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 920. Combinations of any of the above should also be included within the scope of computer readable media that may be used to store source code for implementing the methods and systems described herein. Any combination of the features or elements disclosed herein may be used in one or more examples.

In describing preferred examples of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for managing a customer ordering point that is connected to a plurality of vendor systems, the method comprising:
receiving an electronic communication including a first order having a first plurality of order components, wherein a first order component requires fulfillment from a first vendor system and a second order component requires fulfillment from a second vendor system;
determining from information embedded in the electronic communication that the first order component should be fulfilled from the first vendor system and the second order component should be fulfilled by the second vendor system;
initiating communication with the first vendor system and the second vendor system; and
causing the first vendor system to fulfill the first order component and the second vendor system to fulfill the second order component.

2. The method of claim 1, further comprising:
receiving a second order that includes a second plurality of order components.

3. The method of claim 2, further comprising utilizing at least one predetermined criteria to determine priority of the first order relative to the second order.

4. The method of claim 3, wherein utilizing the at least one predetermined criteria comprises selecting the first order to have priority over the second order because it was received first.

5. The method of claim 4, wherein utilizing the at least one predetermined criteria comprises employing a first predetermined criteria and a second predetermined criteria.

6. The method of claim 5, wherein the second predetermined criteria has a greater weight than the first predetermined criteria.

7. The method of claim 6, wherein the first predetermined criteria is a relative time of receipt of the first order and the second order, and the second predetermined criteria is a relative size of the first order and the second order.

8. The method of claim 1, wherein determining comprises dynamically analyzing the first order component and the second order component to determine that the first order component should be fulfilled by the first vendor and the second order component should be fulfilled by the second vendor.

9. The method of claim 1, wherein determining comprises extracting information from the electronic communication to determine that the first order component should be fulfilled by the first vendor and the second order component should be fulfilled by the second vendor.

10. The method of claim 1, further comprising:
identifying characteristics of a user of the ordering point;
utilizing information provided by the first vendor system and the second vendor system to create a custom interface for the user; and
causing the ordering point to share the customer experience with the user.

11. A system for managing a customer ordering point that is connected to a plurality of vendor systems, the method comprising:
a communication interface operable to receive an electronic communication including a first order having a first plurality of order components, wherein a first order component requires fulfillment from a first vendor system and a second order component requires fulfillment from a second vendor system;
an order management module that executes instructions to:
determine from information embedded in the electronic communication that the first order component should be fulfilled from the first vendor system and the second order component should be fulfilled by the second vendor system;
initiate communication with the first vendor system and the second vendor system; and
cause the first vendor system to fulfill the first order component and the second vendor system to fulfill the second order component.

12. The system of claim 11, wherein the communication interface is operable to receive a second order that includes a second plurality of order components.

13. The system of claim 12, wherein the order management module further executes instructions to utilize at least one predetermined criteria to determine priority of the first order relative to the second order.

14. The system of claim 13, wherein the order management module selects the first order to have priority over the second order because it was received first.

15. The system of claim 14, wherein the order management module employs a first predetermined criteria and a second predetermined criteria to determine priority of the first order relative to the second order.

16. The system of claim 15, wherein order management module provides the second predetermined criteria to have a greater weight than the first predetermined criteria.

17. The system of claim 16, wherein the first predetermined criteria is a relative time of receipt of the first order and the second order, and the second predetermined criteria is relative size of the first order and the second order.

18. The system of claim 11, wherein the order management module executes instructions to dynamically analyze the first order component and the second order component to determine that the first order component should be fulfilled by the first vendor and the second order component should be fulfilled by the second vendor.

19. The system of claim 11, wherein the order management module executes instructions to extract information from the electronic communication to determine that the first order component should be fulfilled by the first vendor and the second order component should be fulfilled by the second vendor.

20. The system of claim 11, further comprising user interface management module that executes instructions to:
identify characteristics of a user of the ordering point;
utilize information provided by the first vendor system and the second vendor system to create a custom interface for the user; and
cause the ordering point to share the customer experience with the user.
